(19) United States
(12) Patent Application Publication
(10) Pub. No.: US 2021/0122123 A1
(43) Pub. Date: Apr. 29, 2021

(54) SYSTEM AND METHOD FOR THERMOPLASTIC WELDING USING AN INDUCED THERMAL GRADIENT

(71) Applicant: SPIRIT AEROSYSTEMS, INC., WICHITA, KS (US)

(72) Inventor: Mark Anthony Wadsworth, Sedan, KS (US)

(73) Assignee: SPIRIT AEROSYSTEMS, INC., WICHITA, KS (US)

(21) Appl. No.: 16/663,430

(22) Filed: Oct. 25, 2019

(51) Int. Cl. B29C 65/00; B29C 65/32; B32B 37/06; B32B 27/06

(52) U.S. Cl. CPC B29C 66/347; B29C 65/32; B29K 2701/12; B32B 37/06; B32B 27/06; B29C 66/8122

(57) ABSTRACT

A system and method for thermoplastic composite welding comprising a cooling means and a heat source. The cooling means cools a heat-side laminate so as to create a thermal gradient in the heat-side laminate. The heat source heats the heat-side laminate after the cooling step is initiated but before the thermal gradient dissipates so that a first side of the heat-side laminate closer to the heat source does not deform as faying surfaces of the heat-side laminate and another laminate farther away from the heat source are welded together.

### BACKGROUND

Thermoplastic composite laminates are often welded together at adjacent faying surfaces via a heat source positioned near a non-faying surface of one of the laminates. The heat source typically has an inverse heat intensity to distance profile, which results in undesired melting or deformation of the non-faying surface.

Heat sinks made of electrically insulative and thermally conductive materials can be positioned between the heat source and the laminates during welding to prevent melting near the heat source, but such materials are rare, expensive, and/or difficult to process. Furthermore, heat sinks increase the heat required and/or slow the welding procedure. Cold fluids have been used to draw heat from the laminates during welding, but this technique is often ineffective because vacuum bags, pressure feet, and other devices used to apply pressure during welding reduce the effective heat transfer coefficient of cold fluids below an acceptable value, thus resulting in a thermal gradient in the laminate near the heat source insufficient to prevent melting or deformation of the laminate's non-faying surface.

### SUMMARY

Embodiments of the present invention solve the above-mentioned problems and other problems and provide a distinct advance in the art of thermoplastic composite welding. More particularly, embodiments of the invention provide a system and method of welding thermoplastic composite laminates together in which a desired pre-welding thermal gradient is established in the laminates.

A first embodiment of the invention is a thermoplastic composite welding system for welding a heat-side laminate and an opposing laminate together. The thermoplastic composite welding system broadly comprises a cooling element and a welding shoe.

The cooling element may comprise a perforated plenum including one or more openings for delivering cold fluid to the heat-side laminate. Alternatively or additionally, the cooling element may comprise a heat sink configured to cool the heat-side laminate by thermal conduction. The heat sink may be cooled by means such as immersion of the heat sink in a cold fluid, circulation of a cold fluid through internal passages within the heat sink, spraying cold fluid onto the heat sink, or by other suitable means.

The heat sink draws heat from the heat-side laminate to cool the heat-side laminate and may be formed of copper, aluminum, or any other suitable thermally conductive material. The heat sink may be formed of an elastomeric or flexible material to enable the heat sink to conform to textures or contours present on the surface of the heat-side laminate.

The welding shoe includes an induction coil and an elastomeric pressure pad for welding the laminates together. The welding shoe may also include a frame or other structural members.

The induction coil includes left and right sides and a magnetic induction region. The left and right sides extend to an electrical power source for passing electrical current through the magnetic induction region. The magnetic induction region is positioned near a bottom end of the welding shoe for generating a magnetic field in the laminates.

The elastomeric pressure pad is positioned near a bottom of the welding shoe below the magnetic induction region of the induction coil. The elastomeric pressure pad promotes contact between the laminates. Specifically, the elastomeric pressure pad promotes compliance to textured or contoured surfaces. The elastomeric pressure pad may comprise the heat sink of the cooling element.

A second embodiment of the invention is a method of thermoplastic welding two laminates together via the above-described welding system. First, the cooling element cools a heat-side laminate in a precooling stage so as to create a thermal gradient therein. For example, a cold fluid may be passed through an internal passage within a heat sink of the cooling element to cool the heat sink. The heat sink may be positioned adjacent to a first side of the heat-side laminate for a period of time, during which the heat sink draws heat from the first side of the heat-side laminate. Alternatively, the cooling element may operate such that the first side of the heat-side laminate may be exposed to a cold fluid for a period of time by means of a perforated plenum or by other means. The period of time during which the heat-side laminate is cooled by the cooling element may be selected to achieve a desired thermal gradient within the heat-side laminate. As such, the first side of the heat-side laminate may be cooled whereas the second side of the heat-side laminate is relatively warmer.

Pressure is then applied to the heat-side laminate and/or the opposing laminate during a heating stage via the elastomeric pressure pad of the welding shoe. This provides compliance to textures or contours of the second side of the heat-side laminate and a first side of the opposing laminate.

The heat-side laminate is then heated in the heating stage via the welding shoe so as to weld the second side of the heat-side laminate and the first side of the opposing laminate (i.e., the faying surfaces) together. Magnetic induction, microwave, radiation, or any other suitable heating mechanism may be used. A temperature of the first side of the heat-side laminate stays below a melt temperature during welding due to the thermal gradient induced during the precooling stage.

The above-described system and method and other embodiments effectively weld two laminates together without melting, deforming, or degrading other portions of the laminates. In particular, a surface of one of the laminates near the heat source is cooled before welding so that its temperature remains below a melt temperature during welding.

A third embodiment of the invention is another method of thermoplastic composite welding two laminates together via a welding system. First, an elastomeric pressure pad of a welding shoe of the welding system is cooled. For example, the elastomeric pressure pad may be introduced to dry ice, liquid nitrogen, a refrigeration cycle, or the like.

The heat-side laminate is then cooled via contact with the elastomeric pressure pad in a precooling stage so as to create a thermal gradient therein. As such, a first side of the heat-side laminate may be cooled whereas the second side of the heat-side laminate is relatively warmer. Pressure is also applied to the heat-side laminate and/or opposing laminate via the elastomeric pressure pad.

The heat-side laminate is then heated in a heating stage via the welding system so as to weld the second side of the heat-side laminate and a first side of the opposing laminate together. A temperature of the first side of the heat-side laminate stays below a melt temperature during welding due to the thermal gradient induced during the precooling stage.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of a thermoplastic composite welding system constructed in accordance with an embodiment of the invention;

FIG. 2 is a side cross section view of a cooling element comprising a perforated plenum of the welding system of FIG. 1;

FIG. 3 is a front elevation view of a welding shoe of the welding system of FIG. 1;

FIG. 4 is a side cross section view of the welding shoe of FIG. 3;

FIG. 5 is a schematic view of a thermal gradient progression in accordance with an embodiment of the invention;

FIG. 6 is a thermal and pressure profile graph in accordance with an embodiment of the invention;

FIG. 7 is a flow diagram depicting certain steps of a method of thermoplastic composite welding in accordance with an embodiment of the invention; and

FIG. 8 is a flow diagram depicting certain steps of a method of thermoplastic composite welding in accordance with another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

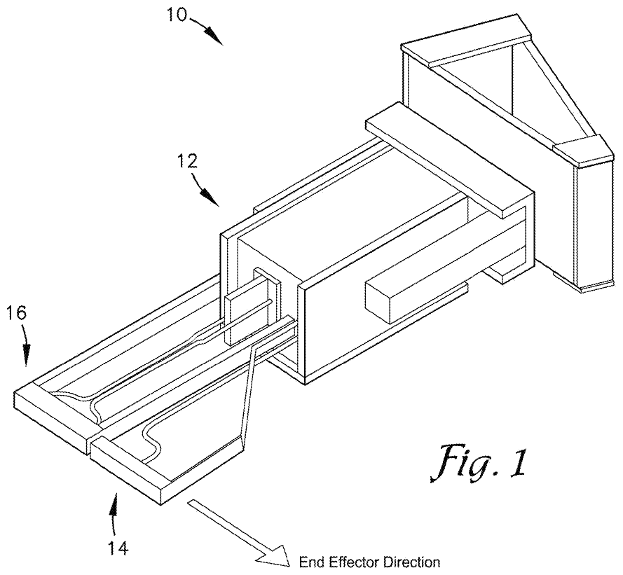

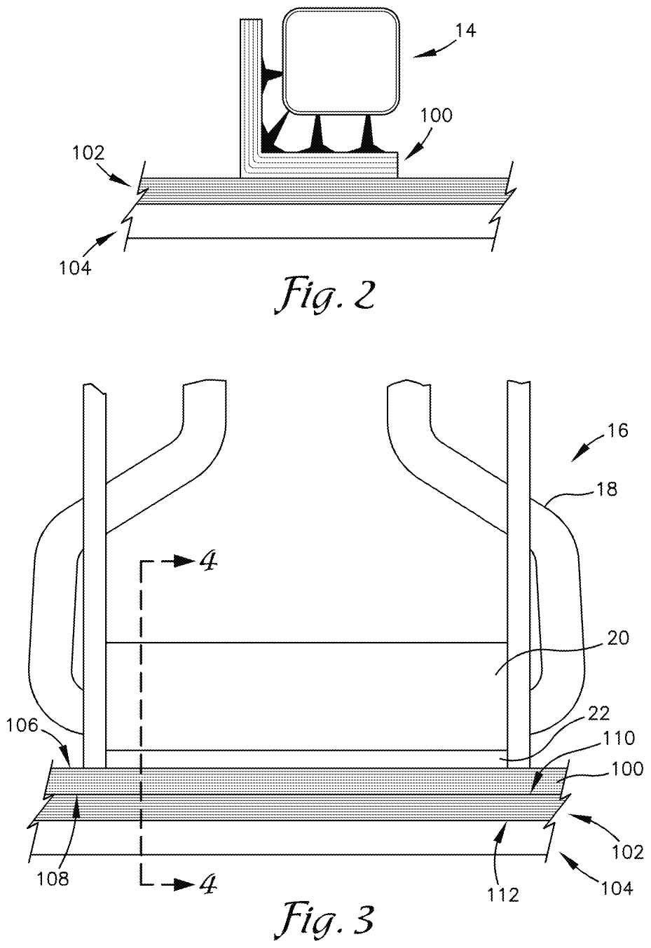

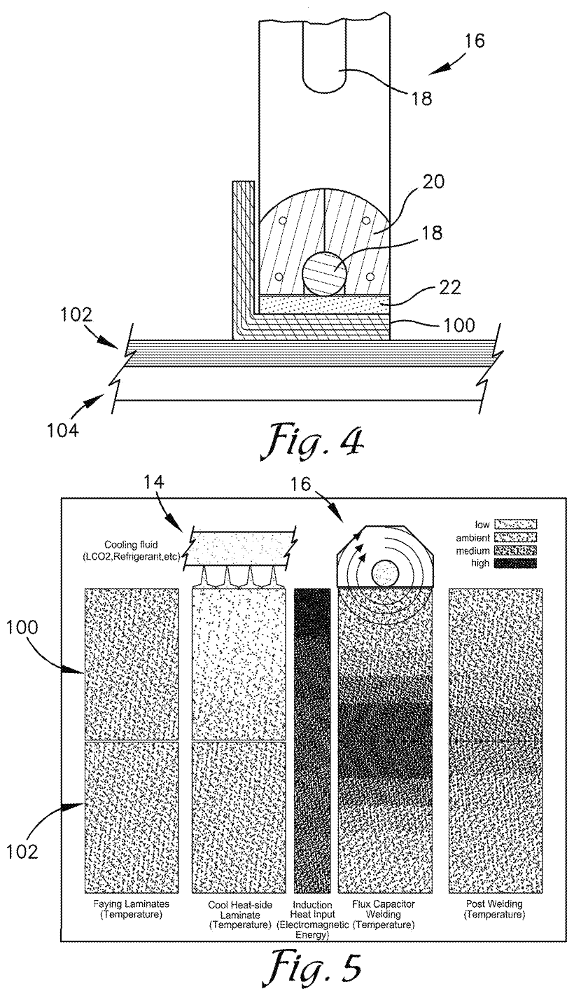

Turning to FIGS. 1-4, a thermoplastic composite welding system 10 constructed in accordance with various aspects of the invention for welding a heat-side laminate 100 and an opposing laminate 102 together is illustrated. The thermoplastic composite welding system 10 broadly comprises a frame 12, a cooling element 14, and a welding shoe 16.

The cooling element 14 may comprise a perforated plenum including one or more openings for dispersing cooled fluid to the first side 106 of the heat-side laminate 100. Alternatively, the cooling element 14 may comprise a heat sink configured to be brought into contact with the first side 106 of the heat-side laminate 100 and to draw heat therefrom. The heat sink may in turn be cooled by immersion in a cold fluid, contact with a cold solid, circulation of a cold fluid through internal passages within the heat sink, or by any other suitable means. In some embodiments, the heat sink of the cooling element 14 may be combined with the elastomeric pressure pad (described below) of the welding shoe 16 as a single device. Other cooling means may be used as described below.

The cooling element 14 may remove heat from the first side 106 of the heat-side laminate 100 to cool the heat-side laminate 100 and create a temperature gradient therein. The cooling element may be formed of plastic, aluminum, elastomeric material, or any other suitable material that is sufficiently thermally conductive and that can operate in close proximity to the induction coil (described below) where required without excessive hysteretic or eddy current heating.

The welding shoe 16 may include an induction coil 18, a magnetic flux control material 20, and an elastomeric pressure pad 22. The welding shoe 16 may be attached to the frame 12 or other structural members.

The induction coil 18 includes left and right sides and a magnetic induction region. The left and right sides extend to an electrical power source for passing electrical current through the magnetic induction region. The magnetic induction region is positioned near a bottom end of the welding shoe 16 for passing an alternating magnetic field through the laminates 100, 102.

The elastomeric pressure pad 22 is positioned near a bottom of the welding shoe 16 below the magnetic induction region of the induction coil 18. The elastomeric pressure pad 22 promotes contact between the laminates 100, 102. Specifically, the elastomeric pressure pad 22 promotes compliance to textured or contoured surfaces. In some embodiments, the elastomeric pressure pad 22 may also function as the heat sink of the cooling element 14.

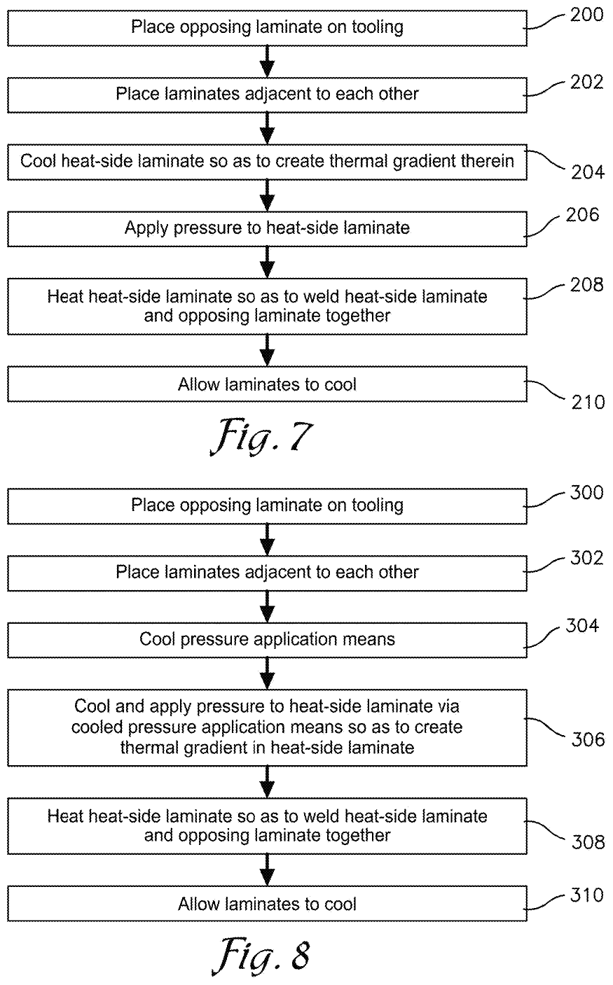

Turning to FIG. 7, and with reference to FIGS. 1-6, a method of thermoplastic composite welding will now be described in detail. First, the opposing laminate 102 may be placed on tooling 104, as shown in block 200. Next, the heat-side laminate 100 may be placed on or adjacent to the opposing laminate 102 (opposite the tooling 104) such that their faying surfaces (e.g., the second side 108 of the heat-side laminate 100 and the first side 110 of the opposing laminate) contact each other, as shown in block 202.

The heat-side laminate 100 may then be cooled in a precooling stage so as to create a thermal gradient therein, as shown in block 204. For example, a cold fluid may be passed through a perforated plenum of the cooling element 14 and dispersed to the first side 106 of the heat-side laminate 100. The cold fluid may then draw heat from the heat-side laminate 100 so as to cool the heat-side laminate 100. The precooling stage may be ended before the temperature through the thickness of the heat-side laminate 100 becomes substantially uniform. Alternatively, the first side 106 of the heat-side laminate 100 may be cooled by other means such as contact with a cold fluid or exposure to a convective cooling jet or cold fluid. As such, the first side 102 of the heat-side laminate 100 may be cooled (to T_{c}) from ambient temperature (T_{amb}) whereas the second side 108 of the heat-side laminate 100 and the first and second sides 110, 112 of the opposing laminate 102 may be relatively warmer.

Pressure may then be applied to the heat-side laminate 100 and/or the opposing laminate 102 during a heating stage to a compaction pressure P_{compaction} via the elastomeric pressure pad 22, as shown in block 206. This provides compliance to textures or contours of the second side 108 of the heat-side laminate 100 and the first side 110 of the opposing laminate 102.

The heat-side laminate 100 may also be heated in the heating stage via the welding shoe 16 so as to weld the second side 108 of the heat-side laminate 100 and the first side 110 of the opposing laminate 102 (i.e., the faying surfaces) together, as shown in block 208. Specifically, an electrical current may be passed through the induction coil 18 to generate a high-frequency alternating magnetic field. The high-frequency alternating magnetic field thereby induces eddy current heating in the heat-side laminate 100. The high-frequency alternating magnetic field may be controlled via the flux control material 20 in the welding shoe 16.

In the heating stage, a temperature of the second side 108 of the heat-side laminate 100 and the first side 110 of the opposing laminate 102 at least temporarily surpasses a melt temperature Tₘ such that matrix resin at those sides is molten. Meanwhile, a temperature of the first side 106 of the heat-side laminate 100, which is closer to the heat source, peaks below a melt temperature Tₘ due to the earlier-induced thermal gradient.

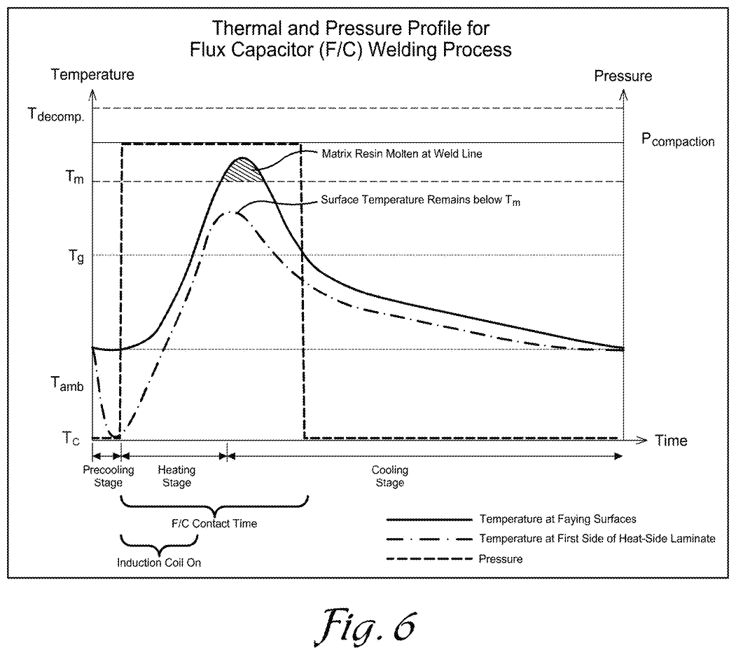

The induction coil 18 may be turned off during the heating stage to effect a desired maximum temperature of the faying surfaces, as depicted in FIG. 6. The faying surfaces and the first side 106 of the heat-side laminate 100 may then begin to cool to T_{amb} in a cooling stage, as shown in block 210. Meanwhile, pressure may be applied to the laminates 100, 102 via the elastomeric pressure pad 22 during the entire heating stage and into the cooling stage.

Furthermore, the elastomeric pressure pad 22 may be withdrawn in the cooling stage so as to reduce pressure on the laminates 100, 102 to zero, as depicted in FIG. 6. In particular, pressure may be reduced or eliminated when the temperature at the faying surfaces decreases below Tₘ. The laminates 100, 102 continue to cool to T_{amb} in the cooling stage.

The above-described system and method provide several advantages. For example, the induced thermal gradient in the laminates 100, 102 provides a thermal sink before welding such that portions of the heat-side laminate 100 do not melt during welding and such that only regions of the laminates 100, 102 near the faying surfaces reach melt temperature (Tₘ). Heat transfer occurs in advance of welding, thus rendering a heat transfer rate (of the laminates 100, 102 in this case) less important. A variability of heat transfer rate between the laminates 100, 102 and any heat sink or other component positioned near the first side 106 of the heat-side laminate 100 can be overcome by varying a cooling time to achieve a desired surface temperature and thermal gradient. The first side 106 of the heat-side laminate 100 also does not undergo deformation or distortion because the first side 106 stays under the melt temperature Tₘ.

Turning to FIG. 8, another method of thermoplastic composite welding will now be described in detail. First, the opposing laminate 102 may be placed on the tooling 104, as shown in block 300. Next, the heat-side laminate 100 may be placed on or adjacent to the opposing laminate 102 (opposite the tooling 104) such that their faying surfaces (e.g., the second side 108 of the heat-side laminate 100 and the first side 110 of the opposing laminate) contact each other, as shown in block 302.

The elastomeric pressure pad 22, serving as the heat sink of the cooling element 14, may then be cooled, as shown in block 304. For example, the elastomeric pressure pad 22 may be introduced to a cool environment, material, or device such as dry ice, liquid nitrogen, a refrigeration cycle, or the like. This reduces the temperature of the elastomeric pressure pad 22.

The heat-side laminate 100 may then be cooled in a precooling stage so as to create a thermal gradient therein, as shown in block 306. Specifically, the elastomeric pressure pad 22 may be positioned adjacent to the first side 106 of the heat-side laminate 100 so as to cool the heat-side laminate 100 and create a thermal gradient therein. The first side 106 of the heat-side laminate 100 may be cooled (to T_{c}) from ambient temperature (T_{amb}) whereas the second side 108 and the first and second sides 110, 112 of the opposing laminate 102 may be relatively warmer. Pressure may also be applied to the heat-side laminate 100 and/or opposing laminate 102 via the elastomeric pressure pad 22.

The heat-side laminate 100 may then be heated in a heating stage via the welding shoe 16 so as to weld the second side 108 of the heat-side laminate 100 and the first side 110 of the opposing laminate 102 together, as shown in block 308. Specifically, an electrical current may be passed through the induction coil 18 to generate a high-frequency alternating magnetic field. The high-frequency alternating magnetic field thereby induces eddy current heating in the heat-side laminate 100. The high-frequency alternating magnetic field may be controlled via the flux control material 20 above the elastomeric pressure pad 22.

In the heating stage, a temperature of the second side 108 of the heat-side laminate 100 and the first side 110 of the opposing laminate 102 at least temporarily surpasses a melt temperature Tₘ such that matrix resin at those sides is molten, as depicted in FIG. 6. Meanwhile, a temperature of the first side 106 of the heat-side laminate 100 peaks below the melt temperature Tₘ due to the earlier-induced thermal gradient.

The faying surfaces and the first side 106 of the heat-side laminate 100 may then begin to cool to T_{amb} in a cooling stage, as shown in block 310. The elastomeric pressure pad 22 may be withdrawn in the cooling stage so as to reduce pressure on the laminates 100, 102 to zero, as depicted in FIG. 6. In particular, pressure may be reduced or eliminated when the temperature at the faying surfaces decreases below Tₘ. The laminates 100, 102 continue to cool to T_{amb} in the cooling stage which may occur more slowly due to the removal of the cool elastomeric pressure pad 22 allowing additional time above T_{g} for substantial crystallinity to grow.

Having thus described various embodiments of the invention, what is claimed as new and desired to be protected by Letters Patent includes the following:

1. A system for thermoplastic composite welding a heat-side laminate having opposing first and second sides and an opposing laminate having opposing first and second sides together, the system comprising:
a cooling means configured to cool the heat-side laminate so as to create a thermal gradient in the heat-side laminate; and
a welding shoe configured to heat the heat-side laminate after the heat-side laminate is cooled but before the thermal gradient dissipates so that the first side of the heat-side laminate does not deform as the second side of the heat-side laminate and the first side of the opposing laminate are welded together.

2. The system of claim 1, wherein the cooling means includes a perforated plenum configured to disperse cooled fluid to the first side of the heat-side laminate.

3. The system of claim 1, wherein the cooling means includes a heat sink configured to contact the first side of the heat-side laminate.

4. The system of claim 1, wherein the welding shoe comprises an induction coil configured to heat the heat-side laminate via a magnetic field.

5. The system of claim 1, wherein the welding shoe comprises an elastomeric pressure pad configured to press the heat-side laminate and the opposing laminate together.

6. The system of claim 5, wherein the cooling means is the elastomeric pressure pad, wherein the elastomeric pressure pad is configured to function as a heat sink.

7. A method of thermoplastic composite welding, the method comprising the steps of:
placing a heat-side laminate having opposing first and second sides adjacent to an opposing laminate having first and second sides;
cooling the heat-side laminate so as to create a thermal gradient in the heat-side laminate; and
heating the heat-side laminate after the cooling step is initiated but before the thermal gradient dissipates so that the first side of the heat-side laminate does not deform as the second side of the heat-side laminate and the first side of the opposing laminate are welded together.

8. The method of claim 7, wherein the step of cooling the heat-side laminate includes at least one of immersing the first side of the heat-side laminate in a cold fluid, spraying the first side of the heat-side laminate with a cold fluid, positioning a cooled heat sink near the first side of the heat-side laminate, and subjecting the first side of the heat-side laminate to a convective cooling jet.

9. The method of claim 7, the method further comprising the step of applying pressure to at least one of the heat-side laminate and the opposing laminate.

10. The method of claim 9, wherein the pressure is applied via an elastomeric pressure pad.

11. The method of claim 9, wherein the pressure is applied via a pressure application means, the method further comprising the steps of cooling the pressure application means and cooling the heat-side laminate via the cooled pressure application means before heating the heat-side laminate.

12. The method of claim 11, wherein the step of cooling the pressure application means is performed before the step of applying pressure.

13. The method of claim 10, wherein the step of heating the heat-side laminate is performed via a welding shoe having the elastomeric pressure pad.

14. The method of claim 10, wherein the heat sink includes magnetic flux control material, the heating step including induction welding the second side of the heat-side laminate and the first side of the opposing laminate together, wherein the induction welding includes controlling magnetic fields via the magnetic flux control material.

15. The method of claim 7, wherein the induction welding includes exposing at least the heat-side laminate to high-frequency alternating magnetic fields to induce eddy current heating near the second side of the heat-side laminate and the first side of the opposing laminate.

16. The method of claim 7, wherein the step of cooling the heat-side laminate includes the step of passing cooled fluid through an internal passage in a heat sink adjacent to the heat-side laminate.

17. A method of thermoplastic composite welding, the method comprising the steps of:
placing a heat-side laminate having opposing first and second sides adjacent to an opposing laminate having opposing first and second sides;
cooling an elastomeric pressure pad;
cooling the heat-side laminate via the cooled elastomeric pressure pad so as to create a thermal gradient in the heat-side laminate; and
heating the heat-side laminate via a welding shoe after the step of cooling the heat-side laminate is initiated but before the thermal gradient dissipates so that the first side of the heat-side laminate does not deform as the second side of the heat-side laminate and the first side of the opposing laminate are welded together.

18. The method of claim 17, wherein the welding shoe comprises the elastomeric pressure pad, the step of cooling the heat-side laminate including drawing heat from the heat-side laminate to the elastomeric pressure pad.

19. The method of claim 17, wherein the step of cooling the elastomeric pressure pad includes submersing at least a portion of the welding shoe in a cooled fluid.

20. The method of claim 17, wherein the welding shoe repeatedly alternates between cooling the heat-side laminate and heating the heat-side laminate.

21. A method of thermoplastic composite welding, the method comprising the steps of:
placing a heat-side laminate having opposing first and second sides adjacent to an opposing laminate having first and second sides;
cooling the heat-side laminate via a cold fluid so as to create a thermal gradient in the heat-side laminate;
applying pressure to the heat-side laminate via an elastomeric pressure pad; and
heating the heat-side laminate via high-frequency alternating magnetic fields to induce eddy currents near the second side of the heat-side laminate and the first side of the opposing laminate after the cooling step is initiated but before the thermal gradient dissipates so that the first side of the heat-side laminate does not deform as the second side of the heat-side laminate and the first side of the opposing laminate are welded together.
